(19) United States
(12) Patent Application Publication
(10) Pub. No.: US 2012/0084247 A1
(43) Pub. Date: Apr. 5, 2012

(54) AFFECTING USER EXPERIENCE BASED ON ASSESSED STATE

(75) Inventors: Blaise H. Aguera y Arcas, Seattle, WA (US); Scott V. Fynn, Seattle, WA (US)

(73) Assignee: MICROSOFT CORPORATION, Redmond, WA (US)

(21) Appl. No.: 12/896,853

(22) Filed: Oct. 2, 2010

(51) Int. Cl. G06N 5/04

(52) U.S. Cl. 706/50

(57) ABSTRACT

State information about user may be used to affect the way in which an application or service behaves with respect to that user. In one example, inferences about the user are drawn based on user-specific and/or non-user-specific information. Examples of user-specific information may include the user's location, searches the user has performed, purchases the user has made, etc. Non-user-specific information may include bus schedules, movie schedules, maps, etc. Inferences about the user's state may be drawn from this information. Types of state information include flags (relatively transient state information), patterns (recurring state information), and badges (relatively durable state information). State information may be made transparent to the user, and the user may be given a chance to affirm or reject state information that has been inferred about that user.

### BACKGROUND

Software and online services are often designed to customize an experience for an individual user. For example, a user might register his or her choice for the visual appearance of a user interface, or might choose which applications are to run at the time of system start-up, or might choose which widgets are to run on a web page, etc. Additionally, a user can provide various durable information about himself—e.g., his city of residence, his birthday, etc. The user experience can be tailored to this information. Thus, if a user requests a search, the search can be localized to focus on results near the user's residence.

Some services use the user's past behavior to tailor the experience. For example, some retail sites recommend particular products or services based on past behavior. Thus, a site that sells books may recommend additional books to purchase based on what books the user has purchased or looked at in the past. A site that rents movies may recommend movies based on the user's prior rental behavior and/or the user's expressed liking or disliking for certain movies. However, when determining how to tailor the user experience, these systems tend to make relatively limited use of information about the user.

### SUMMARY

Information about a user may be collected or inferred, and the information may be used to affect the user experience. Various types of information about a user are available. Examples of this information include: the user's location, the user's search history, the user's browsing history, the user's purchase history, the user's call pattern, or any other type of information. A “state” of the user may be derived using this information. States may fall into three general categories, which may be referred to as flags, patterns, and badges. Conceptually, a flag is a state that is relatively transient; e.g., “riding the bus from Seattle to Tacoma” is a state that may apply to a user at a given time, but is unlikely to apply permanently. A pattern is a state that may be transient but may also be recurring; e.g., “phones sister every Saturday afternoon” is a pattern in the sense that the user is not constantly in a state of talking to his sister on the telephone, but may enter this state in a predictable pattern. A “badge” is a state that describes a relatively durable fact or inference about a user; e.g., “foodie,” “cyclist,” “has been to Australia,” are examples of badges that may apply to a user. Such badges describe things about a user that are likely to be true permanently or for a long time.

State information about a user, such as flags, patterns, or badges, may be derived from any type of information. For example, the flag “riding the bus from Seattle to Tacoma” might be inferred from a combination of the direction and speed at which the user's device is currently moving (as determined through a Global Positioning System (GPS) receiver), a bus schedule, and the current time of day. The pattern “phones sister every Saturday afternoon” might be determined from the call log on the user's phone. The badge “foodie” might be determined from the user's search history and/or purchase history.

Once state information about the user has been determined, an application or service may use the state information to affect the user experience. Thus, a search engine might serve different results to a user based on what flags, patterns, and/or badges apply to that user. For example, the search term “gondoliers” might return different results (or, at least, might place different results near the top), depending on whether the user who enters the search term has the “Venice tourist” badge or the “Gilbert & Sullivan fan” badge. Or, if a person has the “currently riding the bus” flag, different results might be prioritized, since a person who is riding a bus might be looking for different things than a person who is sitting in his living room might be looking for. A search engine is merely one example of a service and/or application whose behavior could be tailored to a user's state; however, any appropriate type of service and/or application could be tailored in some manner.

In some cases, users may find a program's behavior to be offensive when the user perceives that the program's behavior is based too extensively on facts about the user. For example, the type of books that a person likes to read, or the movies that a person likes to watch, can be readily inferred from an analysis of the person's purchase history. However, many people feel a sense of “creepiness” if an application or service acts as if it knows a person's tastes without having been told of those tastes explicitly. An antidote for this sense of creepiness is transparency. When an application or service tailors its behavior toward a particular fact about a user, the user can be shown the reason for the tailored behavior, and can be given an opportunity to affirm or reject the fact. For example, a user might be shown a list of the flags, patterns, and badges that a system believes to apply to that user, and the user can reject those badges with which the user disagrees. Or, perhaps, the user could affirm that a particular piece of state information about the user is true, but could request that the system not tailor its behavior based on that state information. (E.g., the user affirms that he like the television show “American Idol,” but does not want any search results or recommendations that are based on the fact that he likes “American Idol.”)

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which interactions between a service and a user may be affected by state information.

FIG. 2 is a block diagram of various examples of state information.

FIG. 3 is a block diagram of an example scenario in which state information may be inferred.

FIG. 4 is a block diagram of an example scenario in which state information may be used to affect search results.

FIG. 5 is a block diagram of an example way to use state information.

FIG. 6 is a flow diagram of an example process in which state information about a user may be inferred, and in which the state information may be used to affect a user experience.

FIG. 7 is a block diagram of example components that may be used in connection with implementations of the subject matter described herein.

### DETAILED DESCRIPTION

It has become commonplace for people to use their computers and wireless phones as the first place to find information. For example, in the past someone looking for a restaurant would likely have opened a phone book. Today, it is common for a person looking for a restaurant to type the word “restaurant” and his location into a search engine on a computer or mobile phone. The fact that the world's infrastructure has progressed to the point at which this information can be provided on request is no small technological achievement. However, modern computer users often expect more—that is, they expect that system know at least something about what the user wants before the user even asks. For example, a user who enters the search query “restaurant 98052” into a search engine is likely to get a list of restaurants in Redmond, Wash. (for which 98052 is the zip code). However, if the user lives in Redmond, Wash. and has performed localized searches before, the user may feel that it is overkill to have to enter the zip code. After all, the user's location can be inferred from prior localized searches, from the user's current Internet Protocol (IP) address, etc., in which case it would be sufficient for the user to enter the query “restaurant.”

Some services do remember and/or infer the user's location. For example, the user may enter his or her residence zip code to be remembered for future use, or may have his location inferred from the fact that an IP address tends to be associated with an approximate geographic location. In this way, search results (or other aspects of a service's or application's behavior) may be tailored to the user's actual or presumed location. When a location is remembered or inferred in this way, a search such as “restaurant” or “movie” will find results that are near the user's actual or presumed location. Using this location information about the user may provide convenience to the user. For example, the user might have forgotten to include a location with the search query, or may be entering the query on a phone, where typing the extra characters is inconvenient. However, location is merely one type of information that could be remembered about a user.

Some systems, such as retail web sites, remember a user's prior purchases, or products in which the user expressed interest. These systems may use the remembered information to recommend additional products of interest. But the user's location and/or purchase history are relatively limited types of information on which to base a user experience.

The subject matter described herein may be used to affect the user experience based on many different types of information about the user. When a user uses an application or service, various types of information about the user may become available. The user performs searches, and these searches become part of a history. The user purchases products, which also become part of a history. If the user is using the application or service through a phone, then the user's physical location may be known (either through GPS and/or triangulation facilities that may be available on the phone), as well as the user's call history. Using this type of data, certain state information about the user can be inferred. As noted above, state information may generally be understood to include flags, patterns, and badges, where flags represent relatively transient state information concerning the user (e.g., the user is currently on the bus), patterns represent recurring state information (e.g., the user calls his sister every Saturday afternoon), and badges represent durable information about the user (e.g., the user has traveled to Australia).

Certain types of state information may be determined solely based on data collected about the user's activity. For example, if the user has purchased a plane ticket to Australia, this fact may be sufficient to identify the user as having traveled to Australia. However, certain state information may be derived from data about the user's activity and from some type of external data. For example, a GPS receiver on the user's device may show the user's location, and a bus schedule may show the predicted location of a bus (or some other type of public transit vehicle). If the user's location and movement (as determined through the GPS) coincides with the predicted location and movement of the bus (as determined by the bus schedule), then the flag “riding the bus” may be applied to the user.

Users may have social incentives to participate in the collection and refinement of certain types of state information. In non-computing contexts, badges may be collected by people and may become part of a person's identity. Similarly, the badges that represent durable traits of a computer user may be collected by the user—e.g., the use may enjoy being identified as a Chinese food lover, a cyclist, etc., and may want to ensure that the applications and/or services that he or she uses have accurate information about the user. Moreover, the assignment of badges (or patterns, or flags) may be made transparent to the user, in order to avoid the sense of “creepiness” that some users feel when a computer system appears to know too much about the user without explanation. Thus, the particular badges (or patterns, or flags) that are assigned to the user may be made visible to the user, and the user may be given the opportunity to reject a particular assignment (e.g., the system may conclude that the user loves Chinese food, and the user may have the opportunity to say that conclusion is false), or the user may be able to affirm the assignment of a flag, pattern, or badge while also rejecting the user of that flag, pattern, or badge in affecting the system's behavior.

Assuming that a flag, pattern, or badge has been assigned to a user (and that the assignment, or its use, has not been rejected by the user), the flag, pattern, or badge may be used to affect the user experience in a wide variety of ways. In one example, state information about the user may be used to disambiguate search queries—e.g., the search query “gondoliers” may have a different meaning depending on whether the user who enters the query has the “Toured Italy” badge or the “loves Gilbert & Sullivan” badge. Or, as another example, if a pattern indicates that a user calls his sister, whose name is Michelle, every Saturday afternoon, then the word “Michelle,” when entered into a phone, might be interpreted as a request to initiate a call to that person if the term is entered on Saturday afternoon, but might be interpreted as a search query or e-mail address at other times. Or, as a further example, if the user currently has the “riding the bus” flag, then it might be assumed that the user is more interested in listening to music than making telephone calls (since some users listen to music while traveling and avoid making phone calls on public vehicles), so a search term that could be either the name of a musician or a phone contact may be disambiguated in favor of the musician when the “riding the bus” flag applies. As an additional example, ads could be targeted based on which flags, patterns, and/or badges apply to a user. E.g., research might show that people who ride the busses are more likely to be interested in electronics than in sport utility vehicles, so, when the “riding the bus” flag applies, ads for wireless 4G could be served instead of ads for custom sport utility vehicle accessories. Or, if a flag such as “currently shopping at a warehouse club store” applies to a user, then specific ads and/or coupons could be served to the user that are appropriate to the store (or type of store) at which the user is shopping.

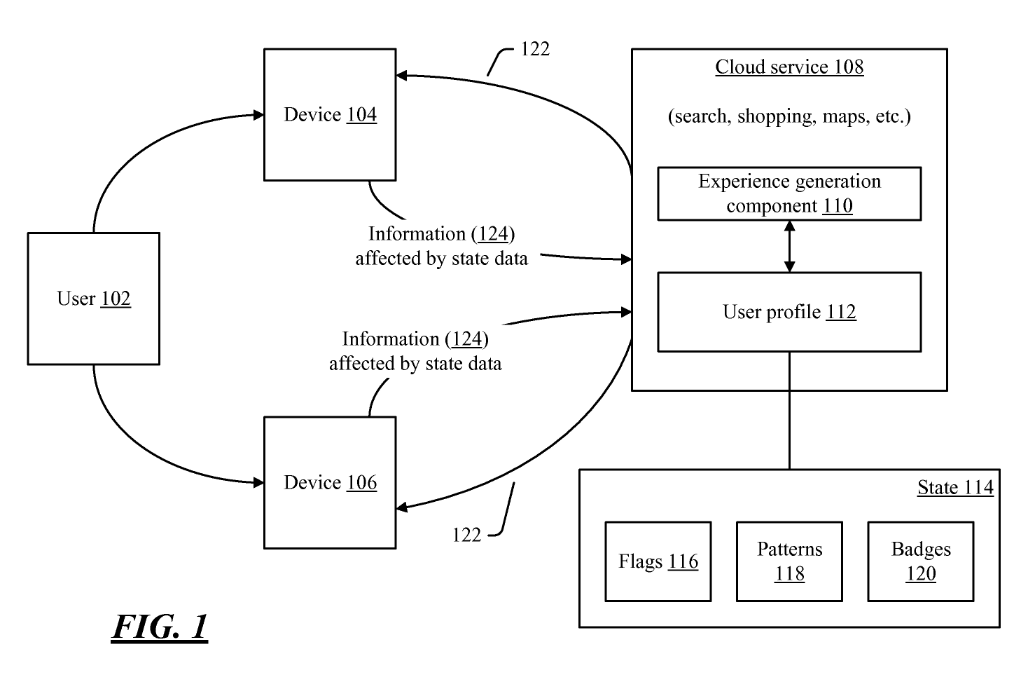

Turning now to the drawings, FIG. 1 shows an example scenario in which interactions between a service and a user may be affected by state data. User 102 is a user of various types of devices, such as a desktop computer, laptop computer, handheld computer, wireless telephone, etc. In FIG. 1, two example devices 104 and 106 are shown, although user 102 could use any number of devices. Device 104 and 106 are used to access cloud service 108. For example, devices 104 and 106 may have browsers and/or other client software that allows a user to interact with cloud service 108 through a network such as the Internet, an intranet, the wired and/or wireless telephone system, etc. Cloud service 108 could be any type of service. For example, cloud service 108 might be a search engine service, a portal service, a shopping service, a map service, or some combination of these and/or other services.

Cloud service 108 may use or comprise an experience generation component 110, which generates the data that is used to create a user experience. For example, if cloud service 108 is a search engine, then experience generation component 110 may generate search results to be displayed on a browser (or through some other type of client software). If cloud service 108 is a map service, then experience generation component 110 may generate maps and/or directions. If cloud service 108 is a shopping service, then experience generation component 110 may generate on-line catalogues of products, purchase recommendations, shopping carts, account management interfaces, or any other type of experience related to shopping. The foregoing are some examples of a cloud service 108, and of the type of experience that cloud service 108 may generate. However, the subject matter herein is not limited to any particular type of cloud service 108.

Cloud service 108 may maintain a user profile 112 for each user who uses cloud service 108. User profile 112 may include various types of information about a user. One type of information about a user that may be included in user profile 112 is state information 114. State information 114 may include flags 116, patterns 118, and/or badges 120. As noted above, flags 116 may represent relatively transient properties of a user, patterns 118 may represent recurring properties (e.g., information that is true about the user recurrently, even if it may not be true about the user constantly), and badges 120 may represent durable properties of the user. Experience generation component 110 may interact with user profile 112 in order to create an experience that is based on information in user profile 112. Thus, the experience that experience generation component 110 creates for a given user may be based on that user's profile, including state information 114. In terms of specific examples, if a user has, say, a “visited Australia” badge, then experience generation component 110 may tailor the experience that it creates in some way that is particularly appropriate for someone who has visited Australia. If a user has the “riding the bus” flag, then experience generation component 110 may tailing the experience in some way that is particularly appropriate for someone who is currently riding a bus.

Thus, user 102 may use device 104 and 106 to contact cloud service 108 (as indicated by arrows 122) in order to perform some type of function with cloud service 108. In response, experience generation component 110 may generate some type of information 124 that is affected, in some manner, by state information 114. Cloud service 108 may deliver this information to device 104 or device 106 (e.g., in the form of a web page to be displayed on a browser or other client software on one of those devices).

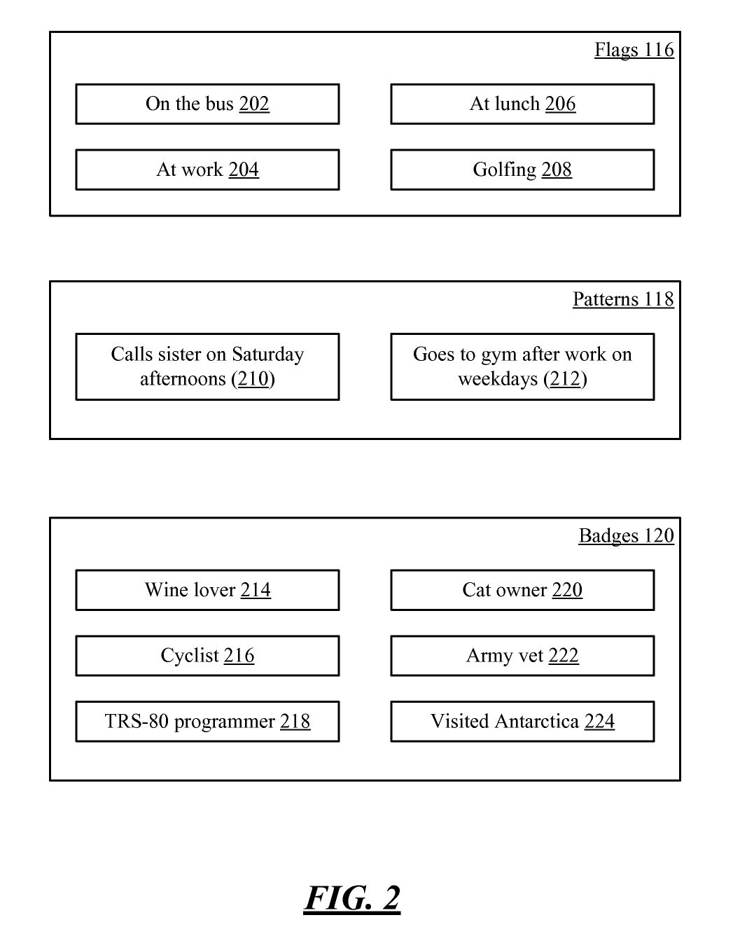

As noted above, state information 114 may take various forms. FIG. 2 shows various examples of the different kinds of state information.

One type of state information is flags 116. As noted above, flags 116 represent relatively transient types of state information—e.g., facts about a user that tend to apply at some times and not at others. FIG. 2 shows various types of flags 116. One example of a flag is the “on the bus” flag 202. It may be determined based on factors such as a person's location and apparent motion, a bus schedule, or other factors, that a person is currently riding a bus, in which case flag 202 may be determined to apply to that person. Other examples of flags are the “at work” flag 204, the “at lunch” flag 206, and the “golfing” flag 208. The applicability of these flags may be determined based on information such as a person's location, the time of day, maps showing where offices, restaurants, and golf courses are located, payment history, etc. For example, it might be determined that a person has, in the last hour, used his phone to reserve a tee time and to make an online payment for a greens fee, and his phone's GPS receiver reports that his physical location coincides with a golf course. On this basis, it may be determined that the “golfing” flag 208 currently applies to that person. When the person finished playing golf, he may leave the course thereby causing his geographic location no longer to coincide with the golf course, so the “golfing” flag 208 could then be removed. In this sense, flags represent information that is true about a person, but that may change rapidly. It is noted that the “golfing” flag 208 might be distinct from, say, a “golfer” badge. The “golfing” flag may indicate that a person is golfing right now (a transient state), while a “golfer” badge might represent the more durable fact that a person is a golfer (even if he or she is not golfing at the moment).

Another type of state information is patterns 118. As noted above, patterns 118 represent states that recur in some manner. FIG. 2 shows two examples of patterns 118. In one example, a person calls his sister on Saturday afternoons (block 210). This pattern could be detected, for example, from the call history on the person's phone. In another example, a person goes to the gym after work on weekdays (block 212). This pattern could be detected, for example, by the person's location at certain times on certain days (as detected, possibly, by the GPS device on the person's phone). The foregoing are some examples of patterns, although any appropriate pattern could be detected.

Another type of state information is badges 120. As noted above, badges 120 represent relatively durable facts about a user. Some examples of badges include the wine lover badge 214, the cyclist badge 216, the TRS-80 programmer badge 218, the cat owner badge 220, the army vet badge 222, and the visited Antarctica badge 224. Some of these badges may be inferred based on a person's behavior. E.g., a person may receive the cyclist badge 216 if his purchase history indicates that he has bought two items of cycling gear in the last month and/or if his pattern of movement (as determined, for example, through a GPS device) suggests that the person has taken some number of cycling trips per week. Or, such a badge may be self-reported. A person may receive the cat owner badge 220 if he has done some number of searches for cat food and/or purchased some amount of cat food under his user name. Some combination of user behavior and/or external information could be used to determine that a particular badge applies to a particular user.

Additionally, flags, patterns, and badges do not have to be inferred based on user behavior or external factors. It is also possible for a user to identify himself or herself as having a particular badge. E.g., a food lover could examine a list of available badges and determine that the “foodie” badge applies to him or her. The user could provide this information to a system, and the system could then exhibit behaviors that are based on the fact that the “foodie” badge applies—just as if the system had inferred the applicability of the “foodie” badge from the user's browsing history. Similarly, the user could communicate to a system that a particular pattern or flag applies to that user.

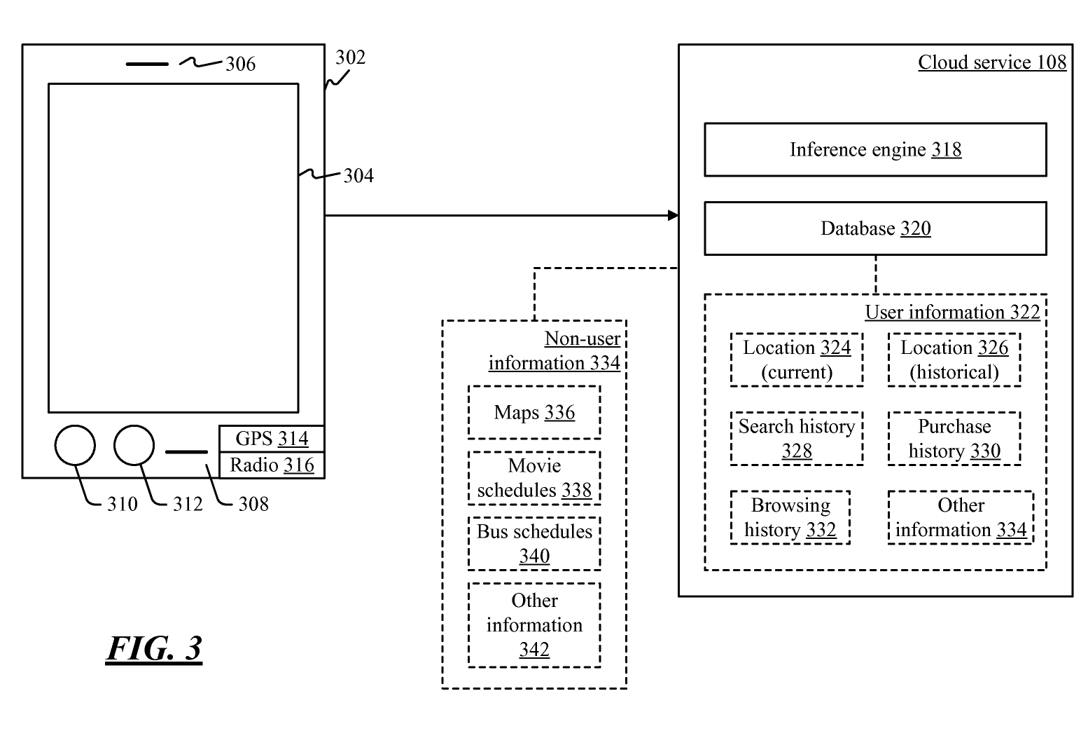

One way to identify the state information that applies to a user is to infer the information from basic facts. FIG. 3 shows an example scenario in which such state information may be inferred. In the scenario of FIG. 3, device 302 is a device that may be associated with a user. In one example, device 302 is a user's wireless phone; thus, in FIG. 3, device 302 is drawn (solely for example purposes) as if it were a smart phone with a touch screen 304. However, device 302 could also be a handheld computer, handheld music player, tablet device, full-size laptop or desktop computer, etc. Device 302 may have various components, such as speaker 306, microphone 308, camera 310, button 312, GPS receiver 314, and radio 316. Speaker 306 and microphone 308 may provide audio output and input, respectively, for device 302. Camera 310 may provide visual input for device 302. Button 312 may provide a mode of allowing a user to interact with software on device 302—e.g., device 302 may be configured to provide a menu of software or other options when a user presses button 312. GPS receiver 314 may receive signals from satellites, and may contain logic to determine the location of device 302 based on those signals. Radio 316 may allow device 302 to engage in two-way communication through electro-magnetic waves (e.g., by allowing device 302 to communicate with cellular communication towers). Touch screen 304 may act as both a visual output device and a tactile input device.

Device 302 may communicate (e.g., using radio 316, or some other type of communications component) with cloud service 108. As described above in connection with FIG. 1, cloud service 108 may have an experience generation component that generates the data to provide some type of user experience (e.g., search, retail, maps, etc.). As also described above, part of the experience that is provided by experience generation component may be an experience that is customized based on state information, such as flags, patterns, or badges. Thus, FIG. 3 shows cloud service 108 as having or using various components that allow the experience to be customized in this manner.

In one example, cloud service 108 may use an inference engine 318 that uses basic facts about a user to infer state information. Inference engine 318 may use a database 320 that stores information 322 about a user. Information 322 may include, for example, information about the user's location (which may include information about the user's current location 324, and/or information about this user's historical location 326). Information 322 may also include the user's search history 328, the user's purchase history 330, the user's browsing history 332, or any other information 334 that may be true about the user. (In order to protect the user's right to privacy, and the user's right to have a say in how information about himself or herself is used, the user may be informed about cloud service 108's privacy policy at the time that the user registers with cloud service 108, and may be given some control over how his or her information is used. Additionally, the manner in which information about the user is used may be made transparent, and the user may be given the opportunity to confirm or reject the applicability of certain information to himself.)

In addition to using user information 322, inference engine 318 may also use non-user information 334 to draw inferences about a user. Non-user information 334 may include, for example, maps 336, movie schedules 338, bus schedules 340, or any other type of information 342. While these types of non-user information may not appear to have anything to do with a user, they can provide context for interpreting a user's actions. As noted in earlier examples, one may want to apply a “riding a bus” flag to a user, if that user is currently on a bus. The bus schedule does not say anything about a particular user, but does provide information from which the user's current location and movement can be interpreted. If a user appears to be moving at the speed of a motor vehicle and is traveling along a known bus route at a time at which the schedule says the bus will be traveling on that route, then inference engine 318 can use both the user's current location and the bus schedule to determine that the “riding the bus” flag applies to the user. Similarly, if the user's location indicates that the user is in a movie theater, then a movie schedule can be used to determine what the user is watching. If the user is repeatedly determined (through analysis of his location and of movie schedules) to be watching science fiction movies, then it might be determined that a “SciFi” badge applies to that user.

The foregoing are merely some examples of how an inference engine 318 could use user information 322 and/or non-user information 334 to apply flags, patterns, and/or badges to a user. However, it will readily be appreciated that an appropriate type of inference could be drawn about a user, based on any appropriate information.

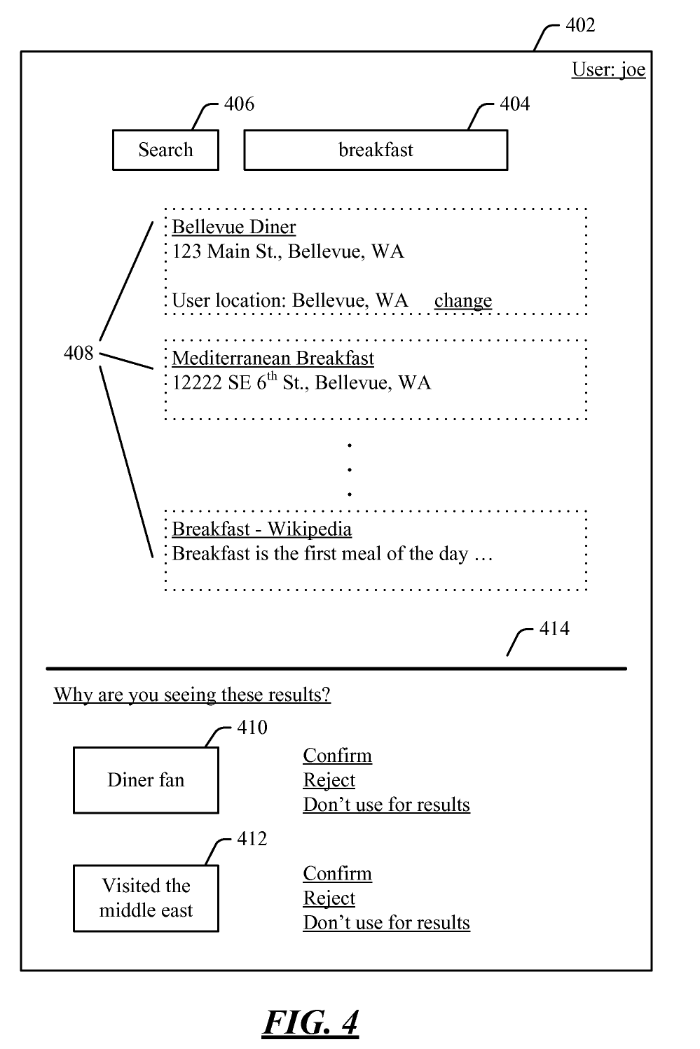

Once state information has been inferred about a user, that state information may be used to affect the behavior of an application or service in a variety of ways. A search engine may use a user's state information to provide results that may be more relevant to a particular user than a general set of results might be. For example, results could be provided that are particularly relevant to the user's presumed interests or tastes (as indicated by a badge), or results that are particularly relevant to a user's current activity (as indicated by a flag). FIG. 4 shows an example of how state information may be used to affect search results. It is noted that search is merely one type of application (or service) whose results may be affected by user state information. The example of a search engine that produces search results is merely used in FIG. 4 to demonstrate this more general principle, and it will be understood that the subject matter herein encompasses the general principle.

FIG. 4 shows a search page 402, which includes a set of results. Search page 402 includes search box 404 and search button 406. Although a search engine can normally be used either anonymously or by a logged in user, in the example of FIG. 4 a user name “joe” is logged in. However, the fact that a user is logged in (or that the search engine otherwise knows the identity of the user who is performing the search) allows the search results to look up that user's state information, and to affect the search results.

In the example of FIG. 4, the user has performed a search for the term “breakfast” by entering that term into search box 404 and clicking button 406. Results 408 for this search are returned by a search engine, and are displayed on page 402. (It will be understood that the search engine may be implemented, for example, by a cloud service 108 (shown in FIGS. 1 and 3). The actual component that produces the search results in response to a search query is an example of an experience generation component 100 (shown in FIG. 1), which may be part of such a cloud service 108.) The results 408 that are shown include the two restaurants named Bellevue Diner and Mediterranean Breakfast. These two results are “local search” type results, although it will be understood that other kinds of results could be shown as indicated by the vertical ellipsis in drawing. (E.g., in addition to specific businesses relating to the term “breakfast”, the results might also include a Wikipedia page about breakfast.) The specific results that are shown in FIG. 4 are affected by various aspects of the user's state information. For example, the fact that both restaurants shown in the results are in Bellevue, Wash. may be due to the fact that the user's location is Bellevue, Wash. Additionally, given that there are many places to eat breakfast in Bellevue, Wash., the user has two specific badges that may have caused the search engine to put these two specific restaurants at the top of the list. The user has the “diner fan” badge 410 and the “visited the middle east” badge 412. The “diner fan” badge 410 may have caused the search engine to choose the Bellevue Diner over other possible restaurants, and the “visited the middle east” badge 412 may have caused the search engine to select Mediterranean Breakfast over other possible restaurants. Thus, FIG. 4 shows an example in which badges are used to affect the behavior of a service—i.e., the badges affect, in this example, the particular way in which a search engine chooses search results for a particular user.

One aspect of the use of state information that is shown in FIG. 4 is transparency. In particular, in the example of FIG. 4, not only does the search engine use state information to affect search results, but also makes it clear to the user how the state information affected search results. Additionally, the system shown also gives the user the opportunity to make changes to the state information and how that state information is used to affect future results. Thus, FIG. 4 shows an area 414 (which, in this example, is part of search page 402, although area 414 could be shown separately). Area 414 explains to the user why the user is seeing the particular set of results shown. It shows that the “diner fan” badge 410 and the “visited the middle east” badge 412 have been determined to be applicable to the user. Area 414 also allows the user to confirm or reject each of these badges. Thus, if the user determines that, say, the “visited the middle east” badge 412 has been incorrectly applied, then the user can reject this badge, so that the search engine will no longer treat that badge as applying to the user. Or, if the badge is correct, then the user can confirm the badge, thereby making the search engine's conclusion about the applicability of that badge to the user even stronger. (A stronger conclusion about the applicability of a badge may increase the effect that a badge has on a system's behavior. Thus, if the system had been slightly skewing results in favor of the presumed tastes of someone who has visited the middle east, after the user confirms the applicability of the badge the system can skew the results even more strongly toward the tastes of someone who has visited the middle east.) Or, as another example, the user could simply say “don't use this badge for results,” thereby telling the system that the user does not want any results skewed by a particular badge, without regard to whether the badge correctly describes the user.

It is noted that another form of transparency that is shown in FIG. 4 is the user's location. In the example of FIG. 4, the user's location is Bellevue, Wash. (as determined, perhaps, by user self-reporting or by the user's IP address). In the example of FIG. 4, what the system believes to be the user's location is made known to the user (by showing that location next to a local search result), and the user is given the opportunity to change that location (through the link labeled “change”).

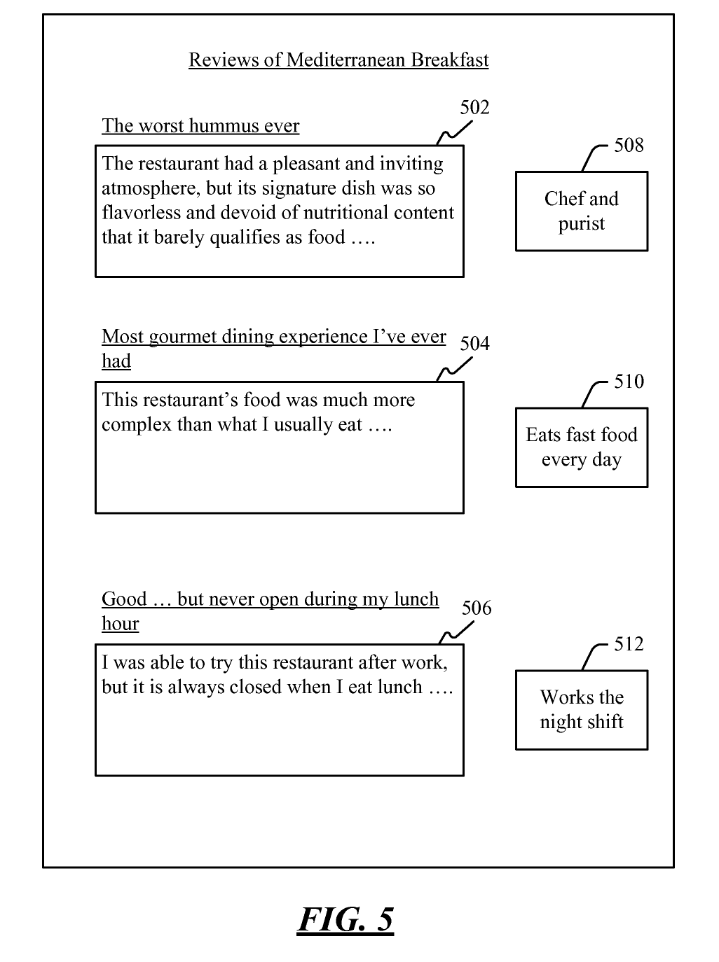

The above discussion shows a way of using state information to affect search results. However, there are numerous ways to use state information. FIG. 5 shows another way to use state information—in particular, a way of using state information in connection with reviews. The example of FIG. 5 shows an example set of reviews of a restaurant (where, in this example, the restaurant being reviewed is the “Mediterranean Breakfast” restaurant of the preceding figure). When the reviews are to be presented, the presentation of these reviews may be generated, for example, by the experience generation component 110 (shown in FIG. 1), and may be tangibly displayed, for example, on a display device. The example of FIG. 5 shows three reviews 502, 504, and 506 of the Mediterranean Breakfast restaurant. Each review is written by a person. The reader of the reviews, however, is unlikely to know the perspective of the person who writes the review. In the example of FIG. 5, visual/textual representations of badges may be used to provide an indication of that perspective. Thus, badges 508, 510, and 512 are associated with the writers of reviews 502, 504, and 506, respectively. The reader of the reviews may use these badges as an indication of whether a given review is one that the reader will take seriously. For example, if a badge indicates that the reviewer's perspective is quite different from the reader's own perspective, the reader may choose to discount the value of the review. Conversely, if the badge suggests that the reviewer's perspective is aligned with that of the reader, then the reader may choose to take the review particularly seriously. As another example, a system may have an understanding of what patterns, flags, and badges apply to a particular user, and can compare this information to that of the reviewer. Using this comparison, the system can identify results with a phrase such as “written by someone like me,” and/or can order the results based on how similar the review is to the user who is requesting the review.

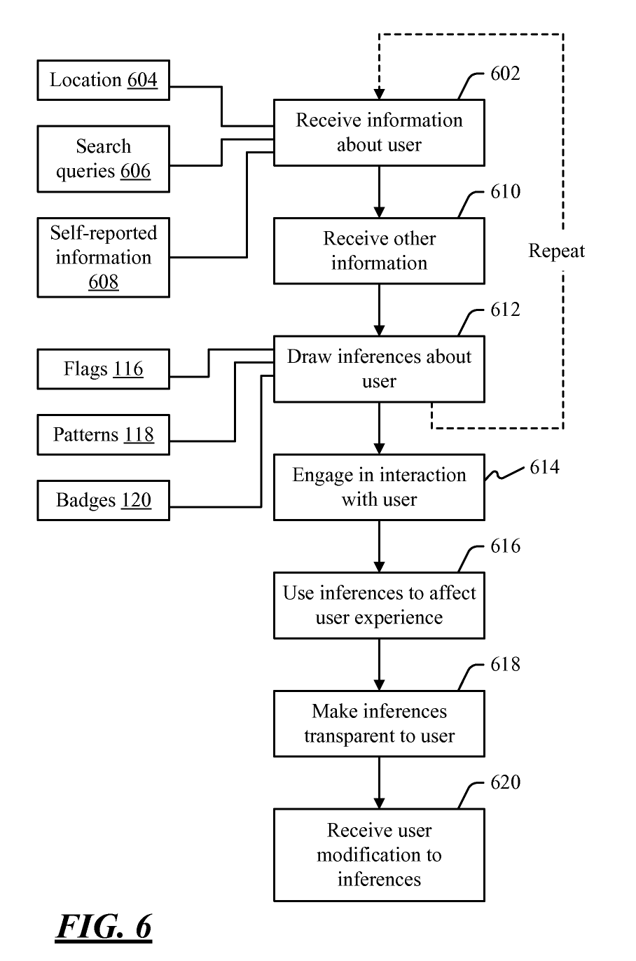

FIG. 6 shows an example process in which state information about a user may be inferred, and in which the state information may be used to affect a user experience. Before turning to a description of FIG. 6, it is noted that the flow diagram in FIG. 6 is described, by way of example, with reference to components shown in FIGS. 1-5, although the process of FIG. 6 may be carried out in any system and is not limited to the scenarios shown in FIGS. 1-5. Additionally, the flow diagram in FIG. 6 shows an example in which stages of a process are carried out in a particular order, as indicated by the lines connecting the blocks, but the various stages shown in this diagram can be performed in any order, or in any combination or sub-combination.

At 602, information about a user is received. For example, the information may include the user's location 604, the user's search queries 606, any self-reported information 608 that the user chooses to report, or any other type of information that is specific to a particular user. At 610, other types of information may be received. Examples of other information include maps, bus schedules, movie schedules, or any other type of information that is not specific to a particular user. At 612, an inference may be drawn about a user. As described above, inferences may be drawn based on information such as the user's search history, purchase history, locations, or any other information about the user, as well as information that is non-specific to the user. As in an example described earlier, the fact that the user is currently moving a particular roadway at a particular speed (the user's location information) combined with a bus schedule (which is an example of information that is not specific to a particular user), it may be inferred that the user is currently riding a bus. This is an example of an interference that can be drawn from both user-specific and non-user-specific information, although it is merely one example of such an inference. As noted above, the inference may constitute state information about the user, and examples of such state information are flags 116, patterns 118, and badges 120. It is noted that the process of receiving information and drawing inferences about a user may be ongoing, and thus may be repeated as indicated in FIG. 6.

At 614, a system that stores state information about a user may engage in an interaction with the user. The interaction may take any appropriate form. For example, the user may enter a search query into a search engine, and the search engine may provide the user with results. Such an exchange between a user and a search engine is an example of an interaction. Or, a user may request, and be provided with, a map or directions. Or, as yet another example, a user may make a purchase using an on-line retail system. All of the foregoing are examples of interactions that may take place at 614, although other types of interactions could take place.

At 616, the inferences that are drawn about the user may be used to affect the nature of the interaction. As described above, the nature of any type of user experience (e.g., search, mapping, etc.) may be affected by the state information that applies to the user. When the state information has been inferred from user-specific and/or non-user-specific information, as described above, the use of this state information to affect the user experience is an example of the action that may take place at 616.

At 618, the inferences that have been drawn about the user's state may be made transparent to the user in some fashion, and (at 620) the use may be allowed to modify conclusions drawn from those inferences. For example, FIG. 4, as discussed above, shows how the user may be told which items of state information are used to select certain search results, and the user may be allowed to confirm or reject those items of state information. In this way, FIG. 4 shows one non-limiting example of a situation in which the user's state information is made transparent to the user, and in which modifications to that state information may be made.

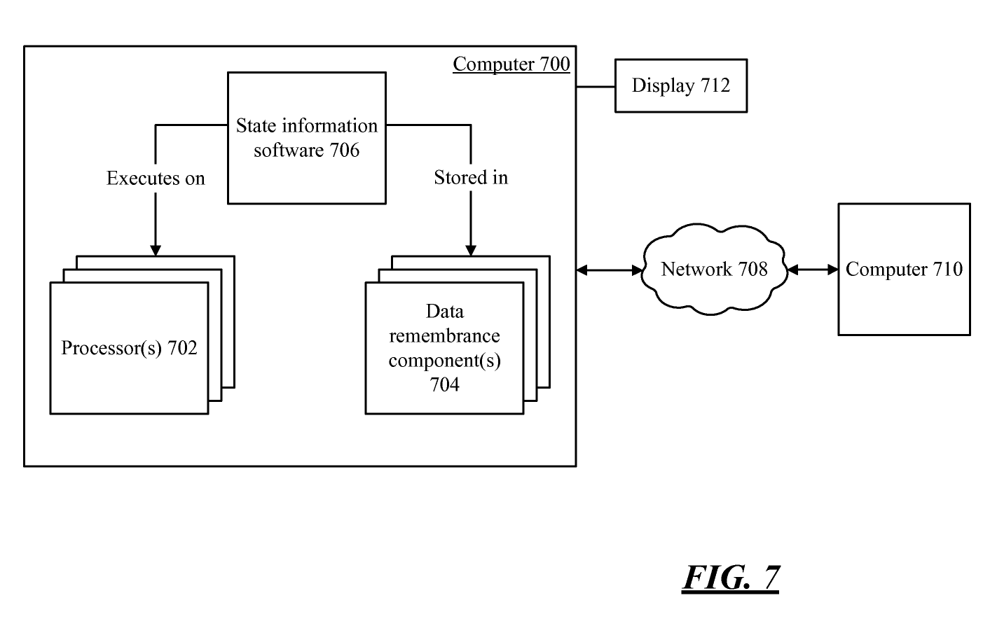

FIG. 7 shows an example environment in which aspects of the subject matter described herein may be deployed.

Computer 700 includes one or more processors 702 and one or more data remembrance components 704. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 700 may comprise, or be associated with, display 712, which may be a cathode ray tube (CRT) monitor, a liquid crystal display (LCD) monitor, or any other type of monitor.

Software may be stored in the data remembrance component(s) 704, and may execute on the one or more processor(s) 702. An example of such software is state information software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 702) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 700 may be communicatively connected to one or more other devices through network 708. Computer 710, which may be similar in structure to computer 700, is an example of a device that can be connected to computer 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of providing search results in a manner that is specific to a user, the method comprising:
using a processor to perform acts comprising:
receiving first information that relates to said user;
deriving second information from said first information, said second information being distinct from said first information, wherein said second information comprises a first inference of a state of said user;
receiving a search request from said user;
generating search results from said search request, wherein said search results are based on said second information; and
communicating said search results to a device associated with said user.

2. The method of claim 1, wherein said second information comprises a flag that represents a transient property of said user.

3. The method of claim 1, wherein said second information comprises a pattern that represents a property of said user that is true recurrently, but not constantly.

4. The method of claim 1, wherein said second information comprises a durable aspect of said user.

5. The method of claim 1, wherein said acts further comprise:
deriving said second information from a behavior of said user, wherein said behavior comprises a search history, a purchase history, or physical movement of said user.

6. The method of claim 1, wherein said acts further comprise:
deriving said second information from third information that is not specific to said user, wherein said third information is distinct from said first information and said second information.

7. The method of claim 1, wherein said acts further comprise:
showing said second information to said user with an indication that said user can confirm or reject applicability of said second information to said user; and
receiving, from said user, an indication of whether said user confirms or rejects said second information as being applicable to said user.

8. One or more computer-readable storage media that store executable instructions to determine state information that applies to a user, wherein the executable instructions, when executed by a computer, cause the computer to perform acts comprising:
receiving first information that relates to a user;
receiving second information that is not specific to said user, said second information being distinct from said first information;
based on said first information and said second information, inferring a state of said user; and
generating data to create a user experience, wherein said data that is created is based on said state that has been inferred for said user.

9. The one or more computer-readable storage media of claim 8, wherein said state comprises a transient property of said user, a pattern that applies recurrently, but not constantly, to said user, or a badge that applies durably to said user.

10. The one or more computer-readable storage media of claim 8, wherein said acts further comprise:
inferring said state from a behavior of said user.

11. The one or more computer-readable storage media of claim 8, further comprising:
communicating said state to said user with an indication that said user can confirm or reject applicability of said state to said user; and
receiving, from said user, an indication of whether applicability of said state is confirmed or rejected.

12. The one or more computer-readable storage media of claim 11, wherein said acts further comprise:
receiving, from said user, an indication that said state is applicable to said user but that said state is not to be used to affect said user experience.

13. The one or more computer-readable storage media of claim 8, wherein said generating of said data to create a user experience comprises receiving a search query and generating a set of search results that is based on said query and on said state.

14. A system for creating a user experience based on state information, the system comprising:
a memory;
a processor;
a state information component that is stored in said memory and that executes on said processor, wherein said state information component comprises:
an inference engine that infers, based on information that relates to a user, state information that applies to said user; and
an experience generation component that generates data to create a user experience, wherein said experience generation component generates said data based on said state information, wherein said state information comprises:
a flag that represents transient information concerning said user;
a pattern that represents information that is recurrently, but not constantly, true about said user; or
a badge that represents durable information about said user.

15. The system of claim 14, wherein said inference engine infers said state information from said user's behavior.

16. The system of claim 15, wherein said user's behavior comprises a search history, a purchase history, or a location of said user.

17. The system of claim 15, wherein said inference engine infers said state information based on information that is not specific to said user.

18. The system of claim 17, wherein said information that is not specific to said user comprises a public transit schedule, wherein said state information is that the user is currently riding a particular public transit vehicle, and wherein said state information is based on history of said user's location and on said public transit schedule.

19. The system of claim 14, wherein said inference engine communicates, to said user, an indication that said data is based on said state information, wherein said inference engine allows said user to confirm or reject said state information, and wherein said experience generation component does not use said state information in a case in which said user rejects said state information.

20. The system of claim 14, wherein said experience generation component generates data to present a review that said user has provided, and wherein said experience generation component affects presentation of said review by including a representation of said state information with said review.
